(19) United States
(12) Patent Application Publication
(10) Pub. No.: US 2022/0082675 A1
(43) Pub. Date: Mar. 17, 2022

(54) Rangefinder and Rangefinding Method

(71) Applicant: Nippon Telegraph and Telephone Corporation, Tokyo (JP)

(72) Inventors: Masahiro Ueno, Tokyo (JP); Yuichi Akage, Tokyo (JP); Soichi Oka, Tokyo (JP)

(21) Appl. No.: 17/420,410

(22) PCT Filed: Feb. 4, 2020
(86) PCT No.: PCT/JP2020/004041

§ 371 Date: Jul. 2, 2021

(30) Foreign Application Priority Data
Feb. 19, 2019 (JP) 2019-027168

(51) Int. Cl. G01S 7/4915; G01S 7/481; G01S 17/32; G01S 7/497

(52) U.S. Cl. CPC G01S 7/4915; G01S 7/497; G01S 17/32; G01S 7/4817

(57) ABSTRACT

A range finding apparatus includes an optical system including a correction mirror disposed near an object, and a PDs that detects reflected light obtained when light emitted from a light source and cyclically modulated in intensity is reflected by the object and a correction mirror, and a signal processing device including a range finding device that outputs a distance signal Lₙ indicating a distance to the object, based on a time period until the reflected light is detected by the PDs, a correction mirror range finding device that outputs a distance signal L_{cor} indicating a distance to the correction mirror, and a distance correction device that corrects the distance signal Lₙ, based on the distance signal L_{cor}, and outputs a distance signal L_{n, cor} indicating the distance to the object.

### CROSS-REFERENCE TO RELATED APPLICATIONS

This application is a national phase entry of PCT Application No. PCT/JP2020/004041, filed on Feb. 4, 2020, which claims priority to Japanese Application No., 2019-027168 filed on Feb. 19, 2019, which applications are hereby incorporated herein by reference.

### TECHNICAL FIELD

The present invention relates to a range finding apparatus and a range finding method, and particularly relates to a time-of-flight range finding technique

### BACKGROUND

A known technique for measuring a distance to an object is a time-of-flight (TOF) method. In a TOF range finding process, a time of flight from when laser light is emitted until the laser light is reflected and returned by and from an object is measured, and the time of flight is multiplied by a speed of light to derive a distance to the object (see Non Patent Literature 1).

In a specific example of the TOF range finding technique, Non Patent Literature 2 discloses a range finding apparatus for measuring, by a TOF method, a position of an underground excavator used in a construction work for building a tube channel such as a sewerage tube without excavating a ground.

In addition, in the techniques described in Non Patent Literatures 1 and 2, there is a need of measuring a time period difference between two signals, that is, a reference signal serving as a reference for measuring a time period and a detection signal obtained by photoelectrically converting light reflected by and returned from a surface of an object to be measured in distance. For example, these two signals are captured by using an analog-to-digital converter (ADC) having two channels. At this time, if the time period difference between the two signals is Δt, a measurement value L of a distance to the object is expressed as cΔt/2. Here, c indicates a speed of light.

Such a known range finding apparatus has a problem that accurate range finding is not possible if a timing difference (skew) between the channels of the ADC fluctuates over time. That is, if there is a deviation (skew) in signal acquisition time period between the channels of the ADC, the measurement value L of a distance will fluctuate accordingly. For example, if the detection signal is delayed by δt with respect to the reference signal due to a skew between the channels of the ADC, a measurement value L′ of a distance to the object is c(Δt+δt)/2, and this results in a difference by cδt/2.

In this case, if the skew δt is a fixed value and the skew δt is measured in advance, when the distance is measured, the skew δt measured in advance is subtracted from a time period difference between the reference signal and the detection signal, and as a result, a correct distance is obtained. However, there is a problem that if the skew δt is different in each signal acquisition, a measurement value of a distance is different in each signal acquisition and the accuracy of the obtained distance is decreased.

### CITATION LIST

### Non Patent Literature

NPL1: Koushi Oishi, Mitsuhiko Ota, and Hiroyuki Matsubara, “Measurement of Time of Flight for Plurality of Reflected Light Beams Using FPGA in Laser Radar”, The Institute of Electronics, Information and Communication Engineers, The 2018 IEICE General Conference, Proceedings of Electronics Lecture 2, p. 38, C-12-3, published on Mar. 6, 2018

NPL2: Tooru Kodaira, Shogo Yagi, Kazuo Fujiura, Jiro Mori, and Takeshi Watanabe, “Light Swept Position Measurement System Applying Wavelength Swept Technology”, Optical and Electro-Optical Engineering Contact, Volume 55, No. 8, pp. 18 to 27, published on Aug. 20, 2017

### SUMMARY

### Technical Problem

Embodiments of the present invention have been made to resolve the above problems, and an object thereof is to provide a range finding apparatus and a range finding method capable of highly accurately measuring a distance to an object even if a timing difference (skew) between channels of an ADC fluctuates in each signal acquisition.

### Means for Solving the Problem

In order to solve the problems described above, a range finding apparatus according to embodiments of the present invention includes an optical system including a light source that outputs light cyclically modulated in intensity, an optical splitter that splits the light from the light source into two light beams, an optical deflector that deflects one light beam of the two light beams output from the optical splitter to emit the one light beam toward an object to be measured, a mirror arranged near the object to be measured as viewed from the optical deflector, and a photodetector that detects first reflected light and second reflected light resultant from the one light bean emitted from the optical deflector being reflected respectively by the object to be measured and the mirror, and a signal processing device including a first range finding unit that outputs a first distance signal indicating a distance to the object to be measured, where the first distance signal includes a plurality of the first distance signals, based on a time period from when the one light beam is output from the optical splitter until the first reflected light is detected by the photodetector, a second range finding unit that outputs a second distance signal indicating a distance to the mirror, based on a time period from when the one light beam is output from the optical splitter until the second reflected light is detected by the photodetector, and a distance correction unit that corrects the first distance signal, based on the second distance signal, to output a third distance signal indicating a distance to the object to be measured.

Further, in the range finding apparatus according to embodiments of the present invention, the mirror may be disposed at a position different from a position on a line linking the optical deflector and the object to be measured.

Further, in the range finding apparatus according to embodiments of the present invention, the distance correction unit may output information including a value obtained by subtracting the second distance signal from the first distance signal as the third distance signal indicating the distance to the object to be measured.

Further, in the range finding apparatus according to embodiments of the present invention, the first range finding unit may acquire time information corresponding to each of the plurality of first distance signals evaluated, and the signal processing device may include a time period-angle degree conversion unit that converts the time information acquired by the first range finding unit into information about a degree of a deflection angle by the optical deflector and outputs an angle degree-distance signal in which a degree of a deflection angle and a distance are associated.

Further, in the range finding apparatus according to embodiments of the present invention, the first range finding unit may discretely acquire the first distance signal indicating the distance to the object to be measured at a peak time of a light intensity of the light source.

Further, the range finding apparatus according to embodiments of the present invention may include an interpolation unit that interpolates the third distance signal, based on the first distance signal indicating the distance to the object to be measured and being discretely acquired by the first range finding unit.

Further, in the range finding apparatus according to embodiments of the present invention, the light source may be wavelength swept light source in which a wavelength changes with time, and the optical deflector may include a diffraction grating or a prism.

In order to solve the problems described above, a range finding method according to embodiments of the present invention includes outputting, from a light source, light cyclically modulated in intensity, splitting, by an optical splitter, the light from the light source into two light beams, deflecting, by an optical deflector, one light beam of the two light beams output from the optical splitter to emit the one light beam toward an object to be measured, detecting, by a photodetector, first reflected light and second reflected light resultant from the one light beam emitted from the optical deflector being reflected respectively by the object to be measured and a mirror disposed near the object to be measured as viewed from the optical deflector, outputting a first distance signal indicating a distance to the object to be measured, based on a time period from when the one light beam is output from the optical splitter until the first reflected light is detected by the photodetector, outputting a second distance signal indicating a distance to the mirror, based on a time period from when the one light beam is output from the optical splitter until the second reflected light is detected by the photodetector, and correcting the first distance signal, based on the second distance signal to output a third distance signal indicating a distance to the object to be measured.

### Effects of Embodiments of the Invention

According to embodiments of the present invention, a first distance signal indicating a distance to an object is corrected by using a second distance signal indicating a distance to a mirror disposed near the object, as viewed from the light source, and thus, even if a time period difference (skew) between channels of an ADC fluctuates in each signal acquisition, it is possible to highly accurately measure the distance to the object.

### BREIF DESCRIPTION OF THE DRAWINGS

FIG. 1 is a block diagram illustrating a configuration of a range finding apparatus according to an embodiment of the present invention.

FIG. 2 is graphs for describing an operation of the range finding apparatus according to the present embodiment.

FIG. 3 is a block diagram illustrating an example of a configuration of a computer for realizing a signal processing device according to the present embodiment.

FIG. 4 is a flowchart describing a range finding method according to the present embodiment.

FIG. 5 is a graph describing an uncorrected distance signal according to the present embodiment.

FIG. 6 is a graph describing the uncorrected distance signal according to the present embodiment.

FIG. 7 is a graph describing a corrected distance signal according to the present embodiment.

FIG. 8 is a graph describing the corrected distance signal according to the present embodiment.

FIG. 9A is a graph for describing an effect of the range finding apparatus according to the present embodiment.

FIG. 9B is a graph for describing an effect of the range finding apparatus according to the present embodiment.

### DETAILED DESCRIPTION OF ILLUSTRATIVE EMBODIMENTS

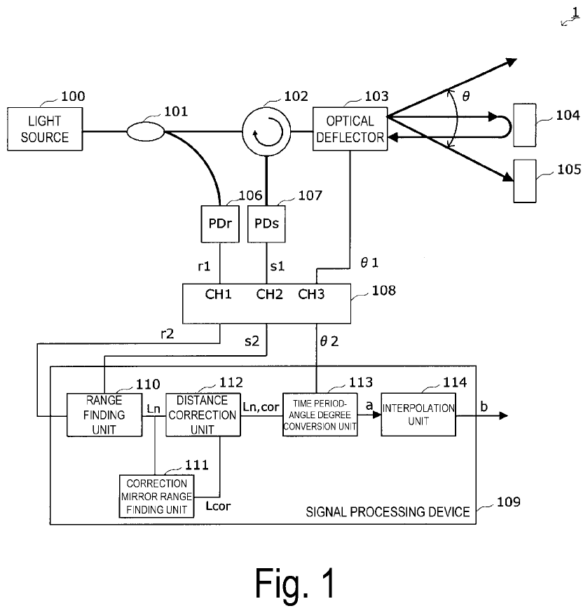

Embodiments of the present invention will be described in detail below with reference to FIGS. 1 to 9B.

FIG. 1 is a block diagram illustrating a configuration of a range finding apparatus 1 according to an embodiment of the present invention. As illustrated in FIG. 1, the range finding apparatus 1 according to the present embodiment measures a distance from the range finding apparatus 1 to an object 104 according to a TOF method. More specifically, the range finding apparatus 1 measures a time of flight from when light from a light source 100 is emitted until the light reflected by a surface of the object 104 to be measured in distance is received, to evaluate a distance from the range finding apparatus 1 to the object 104.

As illustrated in FIG. 1, the range finding apparatus 1 includes the light source 100, a coupler 101, a circulator 102, an optical deflector 103, a correction mirror (mirror) 105, a photodetector (hereinafter, “PDr”) 106, a photodetector (hereinafter, “PDs”) 107, an analog-to-digital converter (ADC) 108, and a signal processing device 109. The coupler 101 is used as a light splitter that splits light.

The light source 100, the coupler 101, the circulator 102, the optical deflector 103, the correction mirror 105, the PDr 106, and the PDs 107 configure an optical system provided in the range finding apparatus 1.

The light source 100 emits light cyclically modulated in intensity toward the object 104. Specifically, the light source 100 generates light cyclically modulated in intensity, such as a sinusoidal wave or a pulse signal. Light emitted from the light source 100 is incident on the optical deflector 103 described below.

The coupler 101 divides light emitted from the light source 100 into a reference optical path and an object optical path. One of the light beams divided by the coupler 101 is input to the PDr 106 on the reference optical path, and the other of the light beams enters, with irradiation, the object 104 and the correction mirror 105 via the circulator 102 and the optical deflector 103 on the object optical path.

The PDr 106 detects light output from the light source 100 and converts the light into a first reference signal r1 that is an analog signal. The resultant first reference signal r1 is input to a channel 1 (CH1) of the ADC 108.

The circulator 102 separates light beams traveling in a direction opposite to each other on an optical path. More specifically, the circulator 102 separates light beams being emitted from the coupler 101 and entering, with irradiation, the object 104 and the correction mirror 105, and light reflected by and returned from the object 104 and the correction mirror 105.

The optical deflector 103 emits light with deflecting an optical axis of light incident from the light source 100. More specifically, the optical deflector 103 deflects and emits light emitted from the light source 100 and incident on the optical deflector 103 via the coupler 101 and the circulator 102. Hereinafter, emitting incident light while changing an optical axis of the incident light by the optical deflector 103 refers to “light being deflected”.

The optical deflector 103 deflects light from the light source 100 within a previously set range of a degree of a deflection angle. An example of the optical deflector 103 includes a deflector using a galvanomirror, a polygon mirror, and a potassium tantalate niobate (KTN) crystal. A degree of a deflection angle of the optical deflector 103 can be set to be in a desired range of a degree of a deflection angle through design of a mirror and a control by a drive device (not illustrated) provided in the optical deflector 103.

The optical deflector 103 deflects and emits light from the light source 100 to scan (sweep spatially, that is, deflect) the object 104, the correction mirror 105, and a space around the object 104 and the correction mirror 105, and reflects the light by a surface of the object 104 to be measured in distance and the correction mirror 105. Each time the optical deflector 103 performs scanning with light obtained by emitting, within a set range of a degree of a deflection angle, light from the light source 100, reflected light (first reflected light) from the object 104 and reflected light (second reflected light) from the correction mirror 105 are each detected by the PDs 107 described below.

As illustrated in FIG. 1, the correction mirror 105 is disposed near the object 104 as viewed from the optical deflector 103. Specifically, the correction mirror 105 is disposed at a position different from a position on a line connecting the object 104 and the optical deflector 103. For example, the correction mirror 105 may be disposed near an end of a deflection range of the optical deflector 103. More preferably, when the correction mirror 105 is disposed at the end of the deflection range of the optical deflector 103, it is possible to utilize most part of the deflection range for measuring the object 104.

The PDs 107 detects reflected light from the object 104 or the correction mirror 105 via the circulator 102 and converts the reflected light into a first detection signal s1 that is an analog signal. The resultant first detection signal s1 is input to a channel 2 (CH2) of the ADC 108.

The ADC 108 includes three channels and converts an analog input signal into a digital signal and outputs the digital signal. A digital signal output and converted by the ADC 108 in each channel is input to the signal processing device 109. The analog first reference signal r1 input to the channel CH1 is converted into a digital, second reference signal r2, and is input to a range finding unit 110 described below. The first detection signal s1 input to the channel CH2 is also converted into a digital, second detection signal s2 and is input to the range finding unit 110. Further, a first angle degree signal θ1, which is an analog signal indicating a degree of a deflection angle of the optical deflector 103, is input to a channel CH3, and is converted into a digital, second angle degree signal θ2 and is input to a time period-angle degree conversion unit 113 described below.

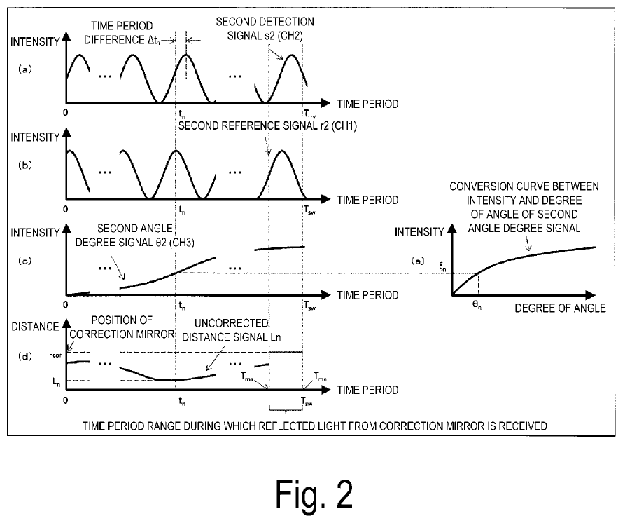

Each of FIGS. 2(a) to 2(c) shows an example of a waveform of a digital signal output from each channel of the ADC 108. Note that FIG. 2 shows a case where light output from the light source 100 is modulated in intensity by a sinusoidal wave. FIG. 2(a) shows a relationship between an intensity and a time period of the second detection signal s2 (CH2) digitized by the ADC 108. FIG. 2(b) shows a relationship between an intensity and a time period of the second reference signal r2 (CH1) digitized by the ADC 108. As shown in FIG. 2, a cycle in which the optical deflector 103 deflects emitted light and performs scanning is represented by T_{sw}.

FIG. 2(c) shows a relationship between an intensity and a time period of the second angle degree signal θ2 (CH3) digitized by the ADC 108. The second angle degree signal θ2 corresponds to a deflection angle. A degree of the deflection angle changes according to a scan cycle (time o to T_{sw}) of the optical deflector 103.

In FIG. 2(c), for simplicity, it is assumed that the deflection angle at time o is immediately restored after the time T_{sw}. However, it is often difficult to actually deflect light as described above, and therefore, after the time T_{sw}, the deflection angle would be changed to reversely follow a transition of the deflection angle at the times o to T_{sw}, and transitioned so that the deflection angle at time 2T_{sw} is the same as the deflection angel at the time o. A cycle in this case is 2T_{sw}. Further, in such a case, in FIG. 2(c), a symmetrical shape centered on the time T_{sw} is established. Alternatively, a mechanism may be employed in which the deflection angle is restored to the degree of an angle at the time o indicated in FIG. 2(c) in a certain constant time period T_{B} rather than immediately. In this case, the cycle is T_{sw}+T_{B}.

As illustrated in FIG. 1, the signal processing device 109 uses, as an input signal, the digital signal from the ADC 108 to calculate a distance from the range finding apparatus 1 to the object 104 for each deflection angle. Specifically, it is possible to evaluate a distance to the object 104 starting from the coupler 101 and a distance to the object 104 from the optical deflector 103 (more exactly, an optical path length).

The signal processing device 109 includes the range finding unit (first range finding unit) 110, a correction mirror range finding unit (second range finding unit) 111, a distance correction unit 112, the time period-angle degree conversion unit 113, and an interpolation unit 114.

Based on the second reference signal r2 and the second detection signal s2 output from the ADC 108, the range finding unit 110 acquires a time of a peak of the second reference signal r2 and measures a distance to the object 104 from the range finding apparatus 1 at that time. In a case where the optical deflector 103 measures the distance within a range of a degree of an angle where light is deflected in a one-dimensional manner, the distance would be measured for each more detailed degree of an angle. In the present embodiment, it is assumed that the distance is measured for each peak of the second reference signal r2. In a case where a distance between peaks is necessary, the interpolation unit 114 described below interpolates the distance between the peaks by using a distance between peak positions to evaluate a more detailed distance to the object 104 from the range finding apparatus 1.

If Tₘ denotes a cycle of an optical modulation of the light source 100 and T_{sw} denotes a cycle of scans of the optical deflector 103 as described above, the number of peaks of the second reference signal r2, is expressed as about Nₚ=T_{sw}/Tₘ. A time at which the optical deflector 103 starts to deflect light is o, and tₙ denotes a time of an nth peak counting from time o. A position corresponding to a broken line commonly shown in a waveform of FIG. 2 is the time tₙ of the nth peak of the second reference signal r2. If a difference between the time tₙ and a peak time of the second detection signal s2 in a range of ±Tₘ/2 is Δtₙ (FIG. 2(a)), the range finding unit 110 calculates a distance Lₙ from the coupler 101 to the object 104 measured at the time tₙ as cΔtₙ/2. Note that c is a speed of light.

Hereinafter, data of a distance corresponding to the time tₙ is particularly referred to as an uncorrected distance signal (first distance signal) Lₙ. Thus, the range finding unit 110 measures a distance on the basis of both reflected light from the object 104 and reflected light from the correction mirror 105, in each cycle in which the optical deflector 103 performs scanning with light. FIG. 2(d) shows an uncorrected distance signal Lₙ evaluated by the range finding unit 110.

Here, in FIG. 2, a range on horizontal axes indicated by dot-dash lines indicates a range of a time period in which reflected light from the correction mirror 105 is detected by the PDs 107. Note that where reflected light from the correction mirror 105 is present in a cycle (the times o to T_{sw}) in which the optical deflector 103 performs scanning with light is evaluated in advance. In the present embodiment, as shown in FIG. 2, it is known in advance that the second detection signal s2 of the reflected light from the correction mirror 105 is present between times Tₘₛ and Tₘₑ. In particular, FIG. 2 shows a case where the time Tₘₑ coincides with the time T_{sw} representing the scan cycle. Such a configuration provides an advantage that a range of a time period in which a distance is originally desired to be measured is a continuous region of the times o to Tₘₛ.

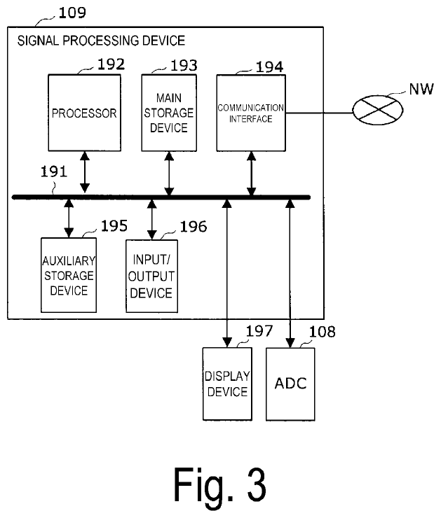

In the present embodiment, at least Tₘₑ−Tₘₛ>Tₘ is required. This is because it is not possible to measure a distance to the correction mirror 105 unless there are at least one peak of the second detection signal s2 and at least one peak of the second reference signal r2 between the times Tₘₛ and Tₘₑ. FIG. 3(c) shows a case where Tₘₑ−Tₘₛ≈Tₘ. Furthermore, if Tₘₑ−Tₘₛ≥3Tₘ, it is possible to accurately measure a position of the correction mirror 105, and hence, more desirable.

If Tₘₑ−Tₘₛ≥3Tₘ, the second detection signal s2 obtained from the reflected light from the correction mirror 105 has three peaks, but the peaks located at the ends, of the three peaks, have a decreased intensity due to an influence that part of the beam does not return from the correction mirror 105 (part of the beam deviates from the correction mirror 105). On the other hand, the peak in the middle of the three peaks is less susceptible to an influence that part of the beam deviates from the correction mirror 105, and is in a signal shape possibly obtained by multiplying a signal having a peak in a cycle Tₘ by an unimodal window function. In such a case, a position of a peak in an area where an inclination is close to o, such as an area near the peak of the window function is mostly the same as a position of the peak obtained when the window function is not yet applied, but a peak in an area with a larger inclination of the window function is more likely to change in position from the original position.

Thus, if there are three peaks, when the peak in the middle less likely to receive an influence by a peak position misalignment is used, it is possible to more accurately measure the position of the correction mirror 105 than in the case of Tₘₑ−Tₘₛ<3Tₘ. As Tₘₑ−Tₘₛ is larger than Tₘ, the influence of the peak position misalignment is likely to be smaller, and thus, the position of the correction mirror 105 is more accurately measured.

The correction mirror range finding unit 111 outputs, as a correction value, a distance signal (second distance signal) indicating a distance to the correction mirror 105, evaluated based on a time period from when light is emitted from the coupler 101 until the reflected light reflected by the correction mirror 105 is received by the PDs 107. More specifically, of uncorrected distance signals Lₙ evaluated by the range finding unit 110, the correction mirror range finding unit 111 evaluates a correction value L_{cor} used by the distance correction unit 112, based on the second detection signal s2 measured in a time period zone from Tₘₛ to Tₘₑ during which light is reflected from the correction mirror 105 in FIG. 2(a).

For example, the correction mirror range finding unit 111 may use an average value of uncorrected distance signals Lₙ in the time period zone from Tₘₛ to Tₘₑ, as the correction value L_{cor}. Alternatively, the correction mirror range finding unit 111 may use a value of the uncorrected distance signal Lₙ at a center time (Tₘₛ to Tₘₑ)/2 in the time period zone from Tₘₛ to Tₘₑ, as the correction value L_{cor}.

Alternatively, the correction mirror range finding unit 111 may acquire a time period zone in which the intensity is not decreased for the uncorrected distance signal Lₙ, and use an average value of uncorrected distance signals Lₙ in the time period zone, as the correction value L_{cor} . A method of acquiring a time period zone in which the intensity is not modulated may include previously selecting a time period zone, and obtaining a peak value in the time period zone from Tₘₛ to Tₘₑ, and thereafter, selecting a time period zone in which there is a peak in a range of a certain ratio (for example, 90%) or more of the peak value.

The distance correction unit 112 corrects an uncorrected distance signal Lₙ evaluated by the range finding unit 110, based on the correction value L_{cor}, and outputs a corrected distance signal (third distance signal) L_{n, cor}. Specifically, the distance correction unit 112 outputs a result obtained by subtracting the correction value L_{cor} from the uncorrected distance signal Lₙ, as the corrected distance signal L_{n, cor}. For example, the corrected distance signal L_{n,cor} at time tₙ is calculated according to Lₙ−L_{cor} . A distance obtained according to such a calculation is a distance in which the correction mirror 105 is a reference of the distance (o m).

In another example, the distance correction unit 112 may calculate the corrected distance signal L_{n, cor} according to Lₙ−L_{cor}+Lₘᵢᵣᵣₒᵣ. Lₘᵢᵣᵣₒᵣ is mirror is a distance precisely evaluated in advance as a distance to the correction mirror 105. When the distance Lₘᵢᵣᵣₒᵣ of the correction mirror 105 is evaluated, for example, a large number of correction values L_{cor} are evaluated in advance and an average value thereof may be used as the distance Lₘᵢᵣᵣₒᵣ of the correction mirror 105.

A distance to the object 104 evaluated according to such a calculation is a distance relative to a difference in optical path length between the coupler 101 to the PDr 106 and the coupler 101 to the PDs 107 starting from the coupler 101, as illustrated in FIG. 1. If the correction mirror 105 is disposed at a position where the distance Lₘᵢᵣᵣₒᵣ of the correction mirror 105 is o m, the correction values L_{cor} are distributed around o m, and therefore, when Lₙ−L_{cor} is calculated, the same value as Lₙ−L_{cor}+Lₘᵢᵣᵣₒᵣ can be obtained.

Further, if a distance L_{deflector, mirror} between the optical deflector 103 and the correction mirror 105 is known in advance, for example by measuring the distance L_{deflector, mirror}, a distance to the object 104 from the optical deflector 103 can be evaluated according to Lₙ−L_{cor}+L_{deflector, mirror}.

The time period-angle degree conversion unit 113 replaces a time at which a peak of the second reference signal r2 acquired by the range finding unit 110 appears, that is, a time corresponding to the corrected distance signal L_{n, cor}, with a deflection angle. For example, it is assumed that the intensity of the second angle degree signal θ2 at time tₙ is ξₙ. The time period-angle degree conversion unit 113 substitutes the intensity ξₙ of the second angle degree signal θ2 into a previously evaluated conversion curve θ(ξ) shown in FIG. 2(e) to obtain a deflection angle θₙ=θ(ξₙ) corresponding to the intensity ξₙ. Thereafter, the time period-angle degree conversion unit 113 outputs deflection angle-distance data (an angle degree-distance signal) a in which the deflection angle θₙ is associated with the corrected distance signal L_{n, cor}. The conversion curve shown in FIG. 2(e) indicates a relationship between the intensity of the second angle degree signal θ2 and a degree of the deflection angle.

The time period-angle degree conversion unit 113 evaluates deflection angles at all peak times included in the second reference signal r2 to output data of a corrected distance corresponding to each of the deflection angles.

The interpolation unit 114 uses interpolation to evaluate the deflection angle-distance data in which the corrected distance signal L_{n, cor} and the deflection angle at a degree of a deflection angle (time) included between peaks of the second reference signal r2 are associated. The interpolation unit 114 outputs data of a distance relative to a more detailed deflection angle (time) included between peaks of the second reference signal r2, as interpolated deflection angle-distance data b. Thus, if the interpolation unit 114 is provided, it is possible to evaluate data more densely indicating a distance in terms of time period (degree of an angle).

Hardware Configuration of Signal Processing Device

Next, an example of a hardware configuration of the signal processing device 109 including the above functions will be described with reference to FIG. 3.

As illustrated in FIG. 3, the signal processing device 109 may be realized by a computer provided with a processor 192 connected via a bus 191, a main storage device 193, a communication interface 194, an auxiliary storage device 195, an input/output device 196, and a program controlling these hardware resources. The signal processing device 109 may be connected with a display device 197 via the bus 191, for example, and display interpolated deflection angle-distance data and the like on a display screen. Further, the signal processing device 109 are connected with the ADC 108 and the optical system of the range finding apparatus 1 via the bus 191 and the input/output device 196.

The main storage device 193 is realized by a semiconductor memory such as SRAM, DRAM, and ROM. A program used by the processor 192 to perform various types of controls and calculations is previously stored in the main storage device 193. With the processor 192 and the main storage device 193, each function of the signal processing device 109 including the range finding unit 110, the correction mirror range finding unit 111, the distance correction unit 112, the time period-angle degree conversion unit 113, and the interpolation unit 114 illustrated in FIG. 1 is realized. In addition, with the processor 192 and the main storage device 193, it is possible to set and control the optical system and the ADC 108.

The communication interface 194 is an interface circuit for communicating with various external electronic devices via a communication network NW. The signal processing device 109 may deliver, for example, the interpolated deflection angle-distance data to outside via the communication interface 194.

Examples of the communication interface 194 include an interface and an antenna that comply with the radio data communication standards such as LTE, 3G, radio LAN, and Bluetooth (registered trademark). The communication network NW includes, for example, Wide Area Network (WAN), Local Area Network (LAN), the Internet, a dedicated line, a radio base station, and a provider.

The auxiliary storage device 195 includes a readable/writable storage medium, and a drive device for reading and writing various information such as a program and data to and from the storage medium. A semiconductor memory such as a hard disk or flash memory which serves as a storage medium can be used as the auxiliary storage device 195.

The auxiliary storage device 195 includes a program storage area for storing a program used by the signal processing device 109 to perform a range finding process, a correction process, a conversion process, and an interpolation process. Further, the auxiliary storage device 195 may include a backup area and the like for backing up the above-described data, programs, and the like.

The auxiliary storage device 195 stores information about a time period range Tₘₛ to Tₘₑ in which reflected light from the correction mirror 105 is received by the PDs 107, where the information is used by the correction mirror range finding unit 111. Further, the auxiliary storage device 195 stores a conversion curve used by the time period-angle degree conversion unit 113 for the conversion process.

The input/output device 196 includes an I/O terminal that receives a signal from an external device such as the display device 197 and outputs a signal to an external device.

Note that the signal processing device 109 may be realized by one single computer and also realized by being distributed over a plurality of computers connected to each other through the communication network NW. The processor 192 may be realized by using hardware such as a field-programmable gate array (FPGA), a large scale integration (LSI), or an application specific integrated circuit (ASIC).

Operation of Range Finding Apparatus

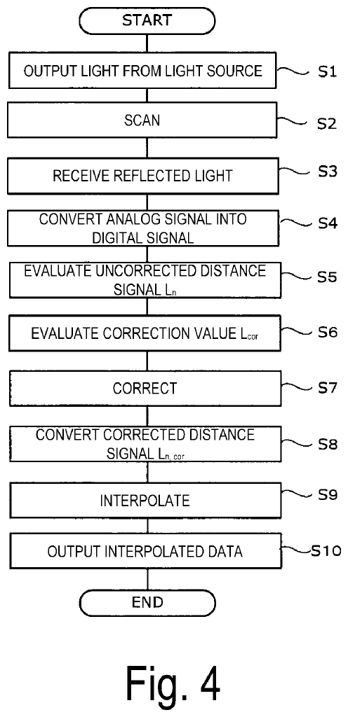

Next, an operation of the range finding apparatus 1 according to the present embodiment will be described with reference to a flowchart of FIG. 4.

Firstly, the light source 100 outputs light cyclically modulated in intensity, for example, light modulated in intensity by a sinusoidal wave (step S1). The light emitted from the light source 100 is divided into a reference optical path side and an object optical path side by the coupler 101. The light on the reference optical path side is received by the PDr 106 and is photoelectrically converted, and the first reference signal r1 is output. On the other hand, the light on the object optical path side is deflected by the optical deflector 103 via the circulator 102, and a space around the object 104 is scanned with the light in a scanning cycle of T_{sw} (step S2).

Next, when the light deflected by the optical deflector 103 scans an area within the space once, each of the object 104 and the correction mirror 105 is irradiated with the light, and the reflected light is detected by the PDs 107 via the optical deflector 103 and the circulator 102 (step S3). Note that the correction mirror 105 may be disposed at a position at the maximum deflection angle, for example. Further, the first angle degree signal θ1 indicating a degree of a deflection angle at which the optical deflector 103 deflects light is input to the channel CH3 of the ADC 108.

Thereafter, the ADC 108 converts an analog signal input to the channels CH1, CH2, and CH3 into a digital signal (step S4). More specifically, the analog, first reference signal r1 is input to the channel CH1 of the ADC 108 where the input first reference signal r1 is converted into the digital, second reference signal r2. The analog, first detection signal s1 based on the reflected light from the object 104 and the correction mirror 105 is input to the channel CH2 of the ADC 108 where the input first detection signal s1 is converted into the digital, second detection signal s2. The first angle degree signal θ1 is input to the channel CH3 of the ADC 108 where the input first angle degree signal θ1 is converted into the digital, second angle degree signal θ2.

Next, in the signal processing device 109, the range finding unit 110 evaluates, based on the second reference signal r2 and the second detection signal s2, an uncorrected distance signal Lₙ and time tₙ corresponding to Lₙ (step S5). More specifically, the range finding unit 110 calculates an uncorrected distance signal Lₙ (FIG. 2(d)) indicating a distance from the range finding apparatus 1 to the object 104 at the time tₙ of each peak of the second reference signal r2 in FIG. 2(b).

Next, the correction mirror range finding unit 111 evaluates a correction value L_{cor} for correcting the distance signal Lₙ evaluated by the range finding unit 110 (step S6). Specifically, as shown in FIG. 2(a), the correction mirror range finding unit 111 calculates a correction value L_{cor}, based on the second detection signal s2 measured in the time period zone from Tₘ to Tₘₑ in which the light is reflected from the correction mirror 105. The correction mirror range finding unit 111 may use, as the correction value L_{cor}, an average value of distances (Lₙ) in the time period zone from Tₘ to Tₘₑ, for example.

Next, the distance correction unit 112 uses the correction value L_{cor} evaluated in step S6 to correct the uncorrected distance signal Lₙ evaluated by the range finding unit 110 in step S5 (step S7). Specifically, the distance correction unit 112 calculates a corrected distance signal L_{n, cor} at the time tₙ according to Lₙ−L_{cor}.

After that, the time period-angle degree conversion unit 113 converts the corrected distance signals L_{n, cor} evaluated in step S7, and outputs deflection angle-distance data a obtained by replacing the peak time of the second reference signal r2 evaluated by the range finding unit 110, that is, time tₙ corresponding to the corrected distance signal L_{n, cor} with the deflection angle θₙ (step S8). More specifically, the time period-angle degree conversion unit 113 reads the conversion curve θ(ξ) shown in FIG. 2(e) previously stored in the auxiliary storage device 195 and the like, substitutes an intensity ξₙ of the second angle degree signal θ2 at the time tₙ into the conversion curve θ(ξ), and converts the time tₙ into a deflection angle θₙ=θ(ξₙ). Further, the time period-angle degree conversion unit 113 evaluates the deflection angle-distance data a in which the deflection angle θₙ and the corrected distance signal L_{n, cor} are associated.

Next, the interpolation unit 114 interpolates a value between peaks of the second reference signal r2, based on the data a in which the deflection angle and the distance are associated, which is evaluated in step S8 (step S9). Thereafter, the interpolation unit 114 outputs interpolated deflection angle-distance data b (step S10).

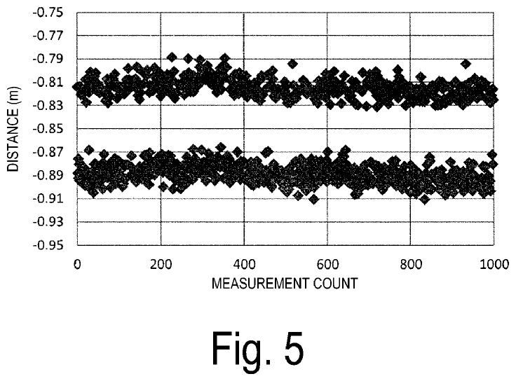

Next, uncorrected and corrected distances to the object 104 at one time, processed by the signal processing device 109 according to the present embodiment are shown in FIGS. 5 to 8.

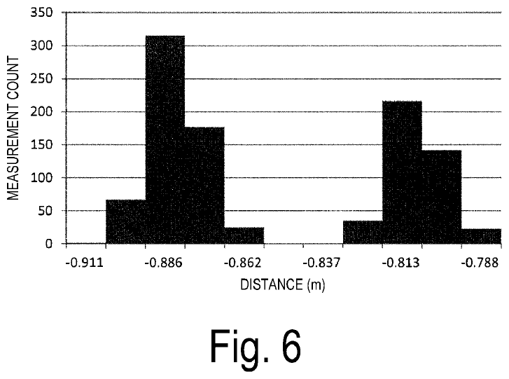

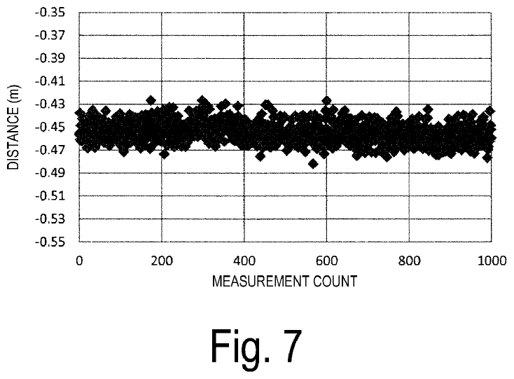

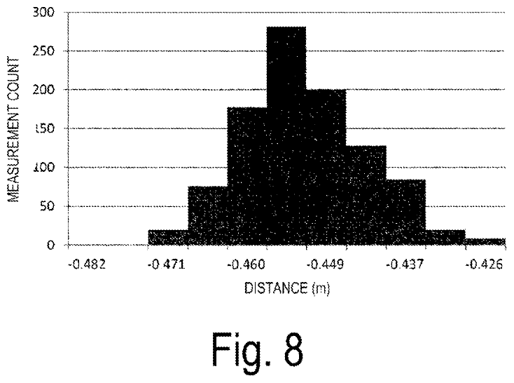

FIGS. 5 and 6 show an uncorrected distance to the object 104, and FIGS. 7 and 8 show a corrected distance to object 104. Further, in FIGS. 5 and 7, measurement values of distances to the object 104 obtained when measurements are repeated 1000 times are plotted. FIGS. 6 and 8 show the measurement values of the distances in histograms.

In examples of the measurement shown in FIGS. 5 to 8, fluctuations over time of a skew between the channel CH2 to which the first detection signal s1 of the ADC 108 was input and the channel CH1 to which the first reference signal r1 was input were grouped into two separate parts, and a difference therebetween was about 0.5 [ns]. Thus, as shown in FIGS. 5 and 6, a difference between an uncorrected distance and a corrected distance was about 7.5 [cm](=3×10⁸×0.5×10⁻⁹/2 [m]).

If the correction process by the signal processing device 109 according to the present embodiment was performed, as shown in FIGS. 7 and 8, it was possible to obtain an effect of eliminating the two separate groups in values of the distance. Note that a standard deviation was 3.7656 [cm] before the correction, and was 0.8654 [cm] after the correction. That is, the standard deviation after the correction was decreased to approximately 23% of the standard deviation before the correction. Thus, the correction process enabled improvement of a distance measurement accuracy.

Further, in FIG. 5, the uncorrected distance is in the vicinity of −0.81 [m] to −0.89 [m], and the corrected distance is concentrated in the vicinity of −0.45 [m]. This is because a distance Lₘᵢᵣᵣₒᵣ of the correction mirror 105 is located in the vicinity of −0.36 [m] to −0.44 [m]. An average value of 1000 correction values L_{cor} by the correction mirror 105 is 0.44749 [m].

When the average value is set to Lₘᵢᵣᵣₒᵣ, and the corrected distance signal is calculated by using Lₙ−L_{cor}+Lₘᵢᵣᵣₒᵣ, it is possible to calculate a distance to the object 104 relative to a difference in optical path length between the coupler 101—the PDr 106 and the coupler 101—the PDs 107 starting from the coupler 101 described in FIG. 1.

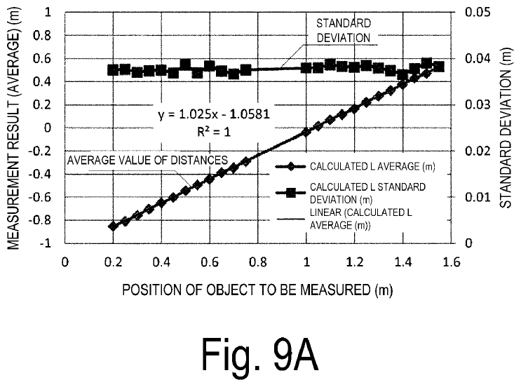

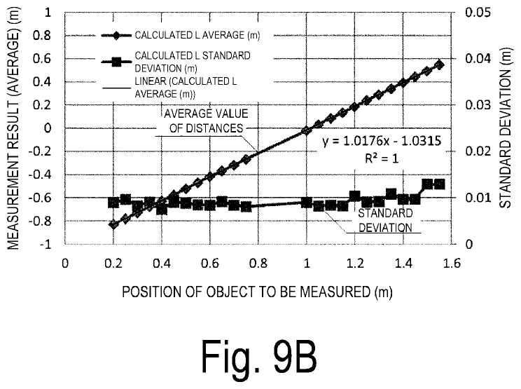

FIGS. 9A and 9B provide results of a distance measured by shifting a position of the object 104 from the starting point by 20 [cm] to 155 [cm] by the range finding apparatus 1 according to the present embodiment. 100 measurements were conducted for each position in which the object 104 was disposed, and average values and standard deviations of uncorrected distances and corrected distances were evaluated.

The standard deviation of the uncorrected distances shown in FIG. 9A was approximately 3.8 [cm], but the standard deviation of the corrected distances shown in FIG. 9B was reduced to approximately 1 [cm]. This indicates that if the correction process by the signal processing device 109 according to the present embodiment is performed, it is possible to improve the distance measurement accuracy.

The average value of the uncorrected distances to the object 104 shown in FIG. 9A and the average value of the corrected distances shown in FIG. 9B are close to each other. This is due to a feature that the correction mirror 105 is disposed at a position where a difference in optical path length between the coupler 101—PDr 106 and the coupler 101—the PDs 107 starting from the coupler 101 as described in FIG. 1 is substantially equal, that is, is almost o m.

As described above, according to the range finding apparatus 1 of the present embodiment, the correction value L_{cor} is evaluated based on reflected light from the correction mirror 105 to correct the distance signal Lₙ from the range finding apparatus 1 to the object 104. As a result, even if a timing difference (skew) between the channels of the ADC fluctuates in each signal acquisition, it is possible to highly accurately measure a distance to the object.

In addition, the range finding apparatus 1 according to the present embodiment interpolates distance data between peaks of the reference signal, and thus, it is possible to highly accurately measure a distance to the object.

Although the embodiment of the range finding apparatus and the range finding method of the present invention has been described above, the present disclosure is not limited to the described embodiment, and various types of modification that can be conceived by a person skilled in the art can be made within the scope of the disclosure described in the claims.

For example, in the described embodiment, a specific example is described where in the signal processing device 109, after the time period-angle degree conversion unit 113 converts the corrected distance signal L_{n, cor} into the deflection angle-distance data a, the interpolation unit 114 performs the interpolation process. However, the interpolation process may be performed before the conversion process by the time period-angle degree conversion unit 113. In this case, the interpolation unit 114 interpolates a value between peaks of the second reference signal r2, based on the corrected distance signal L_{n, cor}, and thereafter, the time period-angle degree conversion unit 113 will convert a time into a deflection angle.

When the interpolation process is performed before the time-angle degree conversion process, the peak time of the second reference signal r2 acquired in the range finding unit 110 cannot be used directly for time information required in the time period-angle degree conversion unit 113. This is because the number of distances obtained in the range finding unit 110 (equal to the number of times obtained in the range finding unit 110) is different from the number of distances output from the interpolation unit 114. Thus, the interpolation unit 114 uses a peak time of the second reference signal r2 acquired in the range finding unit 110 to calculate a time corresponding to the distance information obtained through the interpolation. The time period-angle degree conversion unit 113 uses the time to convert the time into an angle.

In the embodiment described above, a case is described in which light output from the light source 100 is light cyclically modulated in intensity, such as a sinusoidal wave, and is not light swept in wavelength. However, the light source 100 may be a wavelength swept light source including a function of cyclically modulating the intensity. In this case, a passive optical element such as a transmission type or reflection type diffraction grating or a prism made of a material having a large refractive index dispersion, is employed for the optical deflector 103. In addition, even if the light source 100 is a wavelength swept light source including the function of cyclically modulating the intensity, a spatial light modulator well-known as the optical deflector 103 may be employed.

In this case, a grating constant and the like of the diffraction grating may be designed to deflect light within a desired range of a degree of an angle depending on a wavelength of light of the light source 100, a maximum distance required for measurement, a size of the range finding apparatus 1, and the like. Further, likewise, in selecting a wavelength dispersion and a refractive index of the prism, it is possible to select a material having the refractive index and the wavelength dispersion to deflect light at a desired degree of an angle. In addition, if the wavelength swept light source including a function of cyclically modulating the intensity is employed for the light source 100, a configuration is employed in which the first angle degree signal θ1 is linked with a wavelength of light output from the light source 100.

An advantage obtained when the light source 100 is a wavelength swept light source including a function of cyclically modulating the intensity and the optical deflector 103 is a passive optical element such as a diffraction grating and a prism is that it is possible to eliminate a component requiring a mechanical operation from the optical deflector 103. As a result, for example, if the optical system provided in the range finding apparatus 1 is separated into the optical deflector 103 and the others, a deflector is used as a probe and the others are used as a main body, and the probe and the main body are connected via an optical fiber, the size of the probe can be decreased. Thus, a probe unit may be installed in a narrow location and the like, or a person may easily carry the probe unit to measure a distance. Further, the probe does not include a component involving a mechanical operation, and thus, it is possible to increase resistance to vibration of the probe. As a result, the main body and the probe may be separated to place the main body at a location with a slow vibration, and thus, it is possible to provide an exact measurement even under an environment with a strong vibration.

### REFERENCE SIGNS LIST

1 . . . Range finding apparatus

100 . . . Light source

101 . . . Coupler

102 . . . Circulator

103 . . . Optical deflector

104 . . . Object

105 . . . Correction mirror

106 . . . Photodetector PDr

107 . . . Photodetector PDs

108 . . . ADC

109 . . . Signal processing device

110 . . . Range finding unit

111 . . . Correction mirror range finding unit

112 . . . Distance correction unit

113 . . . Time period-angle degree conversion unit

114 . . . Interpolation unit

191 . . . Bus

192 . . . Processor

193 . . . Main storage device

194 . . . Communication interface

195 . . . Auxiliary storage device

196 . . . Input/output device

197 . . . Display device.

1.-8. (canceled)

9. A range finding apparatus, comprising:
an optical system including:
a light source configured to output light that is cyclically modulated in intensity;
an optical splitter configured to split the light from the light source into a first light beam and a second light beam;
an optical deflector configured to deflect the first light beam toward an object to be measured;
a mirror; and
a photodetector configured to detect first reflected light and second reflected light resultant from the first light beam emitted from the optical deflector being reflected respectively by the object to be measured and the mirror; and
a signal processing device including:
a first range finding device configured to output a first distance signal indicating a distance to the object to be measured, wherein the first distance signal includes a plurality of the first distance signals, based on a time period from when the first light beam is output from the optical splitter until the first reflected light is detected by the photodetector;
a second range finding device configured to output a second distance signal indicating a distance to the mirror, based on a time period from when the first light beam is output from the optical splitter until the second reflected light is detected by the photodetector; and
a distance correction device configured to correct the first distance signal, based on the second distance signal, to output a third distance signal indicating a distance to the object to be measured.

10. The range finding apparatus according to claim 9, wherein the mirror is disposed at a position outside of a line extending from the optical deflector to the object to be measured.

11. The range finding apparatus according to claim 9, wherein the distance correction device is configured to output, as the third distance signal, a value obtained by subtracting the second distance signal from the first distance signal.

12. The range finding apparatus according to claim 9, wherein:
the first range finding device is configured to acquires time information corresponding to each of the plurality of first distance signals evaluated, and
the signal processing device includes a time period-angle degree conversion device configured to convert the time information acquired by the first range finding device into information about a degree of a deflection angle by the optical deflector and output an angle degree-distance signal in which a degree of a deflection angle and a distance are associated.

13. The range finding apparatus according to claim 9, wherein the first range finding device is configured to discretely acquire the first distance signal at a peak time of a light intensity of the light source.

14. The range finding apparatus according to claim 13, wherein the signal processing device includes:
an interpolation device configured to interpolate the third distance signal, based on the first distance signal.

15. The range finding apparatus according to claim 9, wherein the light source is a wavelength swept light source in which a wavelength changes with time, and the optical deflector includes a diffraction grating or a prism.

16. A range finding method, comprising:
outputting, from a light source, light that is cyclically modulated in intensity;
splitting, by an optical splitter, the light from the light source into a first light beam and a second light beam;
deflecting, by an optical deflector, the first light beam to emit the first light beam toward an object to be measured;
detecting, by a photodetector, first reflected light and second reflected light from the first light beam emitted from the optical deflector, wherein the first reflected light is reflected by the object to be measured and the second reflected light is reflected by a mirror;
outputting a first distance signal indicating a distance to the object to be measured based on a time period from when the first light beam is output from the optical splitter until the first reflected light is detected by the photodetector;
outputting a second distance signal indicating a distance to the mirror based on a time period from when the first light beam is output from the optical splitter until the second reflected light is detected by the photodetector; and
correcting the first distance signal, based on the second distance signal, to output a third distance signal indicating a distance to the object to be measured.

17. The method according to claim 16, wherein the mirror is disposed at a position outside of a line extending from the optical deflector to the object to be measured.

18. The method according to claim 16, wherein outputting the third distance signal comprises outputting a value obtained by subtracting the second distance signal from the first distance signal as the third distance signal.
